(19) United States
(12) Patent Application Publication
(10) Pub. No.: US 2009/0124517 A1
(43) Pub. Date: May 14, 2009

(54) Microarray having a chemical library of compounds

(75) Inventors: Melissae Stuart, St. Louis, MO (US); Karl Maurer, Mukilteo, WA (US); Kevin D. Moeller, Overland, MO (US)

Correspondence Address: COMBIMATRIX CORPORATION, 6500 HARBOUR HEIGHTS PARKWAY, MUKILTEO, WA, 98275, US

(73) Assignee: CombiMatrix Corporation & Washington University

(21) Appl. No.: 11/985,386

(22) Filed: Nov. 14, 2007

(51) Int. Cl. C40B 40/10; C40B 50/18; C40B 40/00; C40B 40/04

(52) U.S. Cl. 506/18; 506/32; 506/13; 506/15

(57) ABSTRACT

A microarray and a process for making the microarray having a library of chemical compounds are disclosed herein. Each member of the library is attached at a known location. The microarray has a plurality of addressable electrodes and a porous reaction layer attached to each electrode. The porous reaction layer has reactive hydroxyl groups. Michael acceptors are attached to the porous reaction layer of selected electrodes. The Michael acceptors are attached at the hydroxyl groups using electrochemically-generated base that is generated by the selected electrodes and confined to the selected electrodes with the use of excess activated ester. At least one of a plurality of chemical compounds from a library of compounds is attached to the olefin of the plurality of Michael acceptors. Attachment occurs only at the selected electrodes having Michael acceptors with unreacted olefin. Each member of the library of compounds is attached to the known locations.

### STATEMENT REGARDING FEDERALLY SPONSORED RESEARCH

The U.S. Government has a paid-up license in this invention and the right in limited circumstances to require the patent owner to license others on reasonable terms as provided for by the terms of Grant No. CHE-9023698 awarded by National Science Foundation.

### FIELD OF THE INVENTION

This invention provides an electronically addressable microarray with a library of known molecules attached at known locations on the microarray. More specifically, this invention provides a microarray having a library of known different chemical compounds selectively attached to known locations having a porous reaction layer overlaying addressable electrodes of the microarray.

### BACKGROUND OF THE INVENTION

Under limited conditions, microarray technology allows for the synthesis and/or placement of a molecular library of known chemical compounds into a small and defined area at known locations for the purpose of simultaneous screening of the library members for binding to selected receptors. Lipshutz, R. J.; Fodor, S. P. A.; Gingeras, T. R.; Lockhart, D. J. Nat. Genet. 1999, 21, 20; Pirrung, M. Chem. Rev. 1997, 97, 473; Webb, S. M.; Miller, A. L.; Johnson, B. H.; Fofanov, Y.; Li, T.; Wood, T. G.; Thompson, E. B. J. Steroid Biochem. Mol. Biol. 2003, 85, 183; Shih, S.-R.; Wang, Y.-W.; Chen, G.-W.; Chang, L.-Y.; Lin, T.-Y.; Tseng, M.-C.; Chiang, C.; Tsao, K.-C.; Huang, C. G.; Shio, M.-R.; Tai, T.-H.; Wang, S.-H.; Kuo, T.-L.; Liu, W.-T. J. Virol. Methods 2003, 111, 55. Additionally, an addressable microarray of microelectrodes can be used as a platform for synthesizing, analyzing, and screening small molecule libraries. Tian, J.; Maurer, K.; Tesfu, E.; Moeller, K. D. J. Am. Chem. Soc. 2005, 127, 1392; Tesfu, E.; Maurer, K.; Ragsdale, S. R.; Moeller, K. D. J. Am. Chem. Soc. 2004, 126, 6212; Chen, C.; Nagy, G.; Walker, A. V.; Maurer, K.; McShea, A.; Moeller, K. D. J. Am. Chem. Soc. 2006, 128, 16020; and Tesfu, E.; Roth. K.; Maurer, K.; Moeller, K. D. Org. Lett. 2006, 8, 709.

Some previous work focused on using electrochemistry to mediate reactions of palladium, such as the Heck reaction and Wacker oxidation, for site-selective modification of molecules on a microarray. Tian, J.; Maurer, K.; Tesfu, E.; Moeller, K. D. J. Am. Chem. Soc. 2005, 127, 1392; and Tesfu, E.; Maurer, K.; Ragsdale, S. R.; Moeller, K. D. J. Am. Chem. Soc. 2004, 126, 6212. Reactions like the Heck reaction and Wacker oxidation could possibly be used for a diversity-oriented synthesis of a library of compounds directly on a microarray, where a scaffold (reaction layer) is placed over the whole array and defined areas are elaborated in different directions to create a variety of molecules with a common core. Schreiber, S. L. Science 2000, 287, 1964.

The microelectrode platform can have extended use if existing libraries of chemical compounds can be transferred to the surface rather than being synthesized directly on a microarray. This approach would have the benefit of having well characterized and purified compounds placed on a microarray for use in screening experiments such as binding experiments to biological compounds for use in drug discovery. However, any such scheme for transfer of a known library onto a microarray must be performed in a manner that allows registration of each compound of a library to a known location on a microarray. Thus, in order to accomplish registration, a method is needed to accurately map the location of each compound to a known location on a microarray.

Microarray preparation methods for synthetic oligomers, including oligonucleotides include the following: (1) spotting a solution on a prepared flat or substantially planar surface using spotting robots; (2) in situ synthesis by printing reagents via ink jet or other computer printing technology and using standard phosphoramidite chemistry; (3) in situ parallel synthesis using electrochemically generated acid for removal of protecting groups and using standard phosphoramidite chemistry; (4) in situ synthesis using maskless photo-generated acid for removal of protecting groups and using regular phosphoramidite chemistry; (5) mask-directed in situ parallel synthesis using photo-cleavage of photolabile protecting groups (PLPG) and standard phosphoramidite chemistry; (6) maskless in situ parallel synthesis using PLPG and digital photolithography and standard phosphoramidite chemistry; and (7) electric field attraction/repulsion for depositing fully formed oligonucleotides onto known locations.

An electrode microarray for in situ oligo synthesis using electrochemical deblocking is disclosed in Montgomery U.S. Pat. Nos. 6,093,302; 6,280,595, and 6,444,111 (Montgomery I, II, and III respectively), all of which are incorporated by reference herein. Another and materially different electrode array (not a microarray) for in situ oligo synthesis on surfaces separate and apart from electrodes using electrochemical deblocking is disclosed in Southern U.S. Pat. No. 5,667,667, which is incorporated by reference herein. Photolithographic techniques for in situ oligo synthesis are disclosed in Fodor et al. U.S. Pat. No. 5,445,934 and the additional patents claiming priority thereto, all of which are incorporated by reference herein. Electric field attraction/repulsion microarrays are disclosed in Hollis et al. U.S. Pat. No. 5,653,939 and Heller et al. U.S. Pat. No. 5,929,208, both of which are incorporated by reference herein. A review of oligo microarray synthesis is provided by: Gao et al., Biopolymers 2004, 73:579.

Spotting methods of microarray preparation have limitations from the size of the droplet that can be deposited onto the surface of an array. Electrophoretic methods of microarray preparation have limitations that the chemical to be deposited must carry a charge in solution. Additionally, there may be difficulties in firmly attaching molecules such as by covalent bonding. To overcome these problems, the present invention provides a method of microarray preparation using an electrode microarray to selectively react known compounds to known locations on the microarray; thus, registration is maintained of each compound of a library of compounds while each compound is covalently attached to the microarray.

### SUMMARY OF THE INVENTION

The present invention provides a process for making a microarray having a library of chemical compounds that are attached at known locations on the microarray. The process comprises: (a) providing a microarray having addressable electrodes, wherein a porous reaction layer is attached to each one of the addressable electrodes, wherein the porous reaction layer that is attached to each one of the addressable electrodes is a known location, wherein the porous reaction layer has hydroxyl groups; (b) attaching a Michael acceptor having an attaching group to one of the known locations by a base-catalyzed chemical reaction that occurs at the hydroxyl groups, wherein the base for the base-catalyzed chemical reaction is an electrochemically-generated base that is generated by activating the addressable electrode at the known location, wherein the electrochemically-generated base is confined to a region surrounding the addressable electrode at the known location using a scavenging agent; (c) attaching a chemical compound from a chemical library to the olefin of the Michael acceptor that is attached to one of the known locations; and (d) repeating steps (b) through (c) until each member of the chemical library is attached to at least one of the known locations.

Preferably, the attaching group is an activated ester and the base-catalyzed chemical reaction attaching the Michael acceptor is an esterification reaction of the activated ester, wherein the activated ester is the scavenging agent, wherein the activated ester is activated by a chemical selected from the group consisting of succinimide, pentafluorophenol, para-nitrophenol, and hydroxy-benztriazole and combinations thereof. Preferably, the attaching group is selected from the group consisting of acid fluoride, acid chloride, acid bromide, acid iodide, acid anhydride, and imidazolate and combinations thereof, wherein the attaching group is the scavenging agent. Preferably, the scavenging agent is XCOR₁, wherein X is a leaving group selected from the group consisting of fluoride, chloride, bromide, iodide, anhydride, imidazolate, and R₂O—, and combinations thereof, wherein R₁ is selected from the group consisting of alkyl, alkenyl, alkynyl, and aryl and combinations thereof, wherein R₂ is selected from the group consisting of succinimide, pentafluorophenyl, para-nitrophenyl, and benztriazole and combinations thereof. Preferably, the Michael acceptors are selected from the group consisting of N-succinimidyl 3-maleimidopropioate, N-succinimidyl 6-maleimidocaproate, and N-acryloxysuccinimide and combinations thereof. Preferably, excess activated ester is used in solution as a confining agent to prevent the migration of base generated at the selected electrodes to remote, non-selected sites on the array.

Preferably, the step of attaching at least one of a plurality of chemical compounds from a library of compounds to the olefin of the plurality of Michael acceptors, further comprises: attaching using chemical base or electrochemically-generated base generated by the selected electrodes. Preferably, each of the chemical compounds from the library of compounds has a thiol group, wherein the thiol group reacts with the olefin of the Michael acceptors, whereby the chemical compounds from the library of compounds are attached to the Michael acceptors through a sulfide linkage. Preferably, the library of compounds is selected from the group consisting of peptides, peptidomimetics, proteins, DNA, RNA, small molecule drug candidates, diversity oriented synthesis products, and functionalized members of the foregoing and combinations thereof.

The present invention further provides a microarray having a library of chemical compounds that are attached at known locations on the microarray. The microarray comprises: (a) a microarray having addressable electrodes, wherein a porous reaction layer is attached to each one of the addressable electrodes, wherein the porous reaction layer that is attached to each one of the addressable electrodes is a known location, wherein the porous reaction layer has hydroxyl groups; (b) Michael acceptors having an attaching group and attached to each one of the known locations by a base-catalyzed chemical reaction that occurs at the hydroxyl groups, wherein the base for the base-catalyzed chemical reaction is an electrochemically-generated base that is generated by activating the addressable electrode at the known location, wherein the electrochemically-generated base is confined to a region surrounding the addressable electrode at the known location using a scavenging agent; and (c) a chemical compound from a chemical library attached to the olefin of each one of the Michael acceptors.

Preferably, the attaching group is an activated ester and the base-catalyzed chemical reaction attaching the Michael acceptors is an esterification reaction of the activated ester, wherein the activated ester is the scavenging agent, wherein the activated ester is activated by a chemical selected from the group consisting of succinimide, pentafluorophenol, para-nitrophenol, and hydroxy-benztriazole and combinations thereof. Preferably, the attaching group is selected from the group consisting of acid fluoride, acid chloride, acid bromide, acid iodide, acid anhydride, and imidazolate and combinations thereof, wherein the attaching group is the scavenging agent. Preferably, the scavenging agent is XCOR₁, wherein X is a leaving group selected from the group consisting of fluoride, chloride, bromide, iodide, anhydride, imidazolate, and R₂O—, and combinations thereof, wherein R₁ is selected from the group consisting of alkyl, alkenyl, alkynyl, and aryl and combinations thereof, wherein R₂ is selected from the group consisting of succinimide, pentafluorophenyl, para-nitrophenyl, and benztriazole and combinations thereof. Preferably, the olefin of the Michael acceptors is provided by an olefin containing group selected from the group consisting of ethylene and maleimide and combinations thereof. Preferably, the Michael acceptors are selected from the group consisting of N-succinimidyl 3-male-imidopropioate, N-succinimidyl 6-maleimidocaproate, and N-acryloxysuccinimide and combinations thereof. Preferably, excess activated ester is used in solution as a confining agent to prevent the migration of base generated at the selected electrodes to remote, non-selected sites on the array.

Preferably, the plurality of chemical compounds from the library of compounds are attached using chemical base or electrochemically-generated base generated by the selected electrodes. Preferably, each of the chemical compounds from the library of compounds has a thiol group, wherein the thiol group reacts with the olefin of the Michael acceptors, whereby the chemical compounds from the library of compounds are attached to the Michael acceptors through a sulfide linkage. Preferably, the library of compounds is selected from the group consisting of peptides, peptidomimetics, proteins, DNA, RNA, small molecule drug candidates, diversity oriented synthesis products, and functionalized members of the foregoing and combinations thereof.

### BRIEF DESCRIPTION OF THE DRAWINGS

FIG. 1 provides chemical drawings of the Michael acceptors N-acryloxysuccinimide (1), N-succinimidyl 3-maleimidopropioate (2), and N-succinimidyl 6-maleimidocaproate (3) and a pyrene-thiol compound (4) used as a library chemical to react to the Michael acceptors and the peptide KGGRGDSPC (5), with 5(6)-carboxyfluorescein attached to the amine of the lysine side chain, of which was synthesized using Fmoc solid phase peptide synthesis. The general formula for a scavenging agent (6) is also shown.

FIG. 2 provides a scheme for electrochemical addition of a Michael acceptor followed by electrochemical addition of a pyrene-thiol compound to the Michael acceptor.

FIG. 3A provides an image of a 1K electrode microarray according to the reaction performed in FIG. 2.

FIG. 3B provides an image of a microarray according to the reaction in FIG. 2 but on a 12K electrode microarray and with N-acryloxysuccinimide as the Michael acceptor linking the thiol-pyrene compound (4).

FIG. 3C provides an image of a microarray according to the reaction performed in FIG. 2 but with N-succinimidyl 3-maleimidopropioate (2) as the Michael acceptor and peptide (5) as the substrate attached to the Michael acceptor in the second step of the reaction, which was performed in aqueous solution without turning on the electrodes.

### DETAILED DESCRIPTION OF THE INVENTION

In one embodiment disclosed herein, Michael acceptors with activated esters are attached to known locations of the microarray using electrochemically-generated base to catalyze a transesterification reaction at the hydroxyl groups of the porous reaction layer. Only those electrodes turned on as cathodes generate the base and therefore will have the esterification reaction occur on the porous reaction layer at the site of the activated electrodes, i.e. one or more of the known locations. The porous reaction layer attached to each of the electrodes is the known location. Thus, each known location has an electrode associated therewith. The electrode location effectively identifies each known location. Excess activated ester is used in solution as a “confining agent” for keeping base generated at the selected electrodes from migrating to non-selected electrodes. After attachment, the olefin of the Michael acceptor is then treated with a compound from a library of compounds, wherein each compound in the library has a thiol group that reacts to the olefin providing a sulfide linkage to the Michael acceptor.

Preferably, electrochemically-generated base is used for attaching each compound from the library to the known locations using the electrodes at the known locations. Optionally, a chemical base in solution is used for attaching each compound from the library to the Michael acceptor at the selected electrodes. Preferably, the chemical base is a mild base providing a pH between approximately 7.1 and 9.0 and more preferably between approximately 7.3 and 7.7.

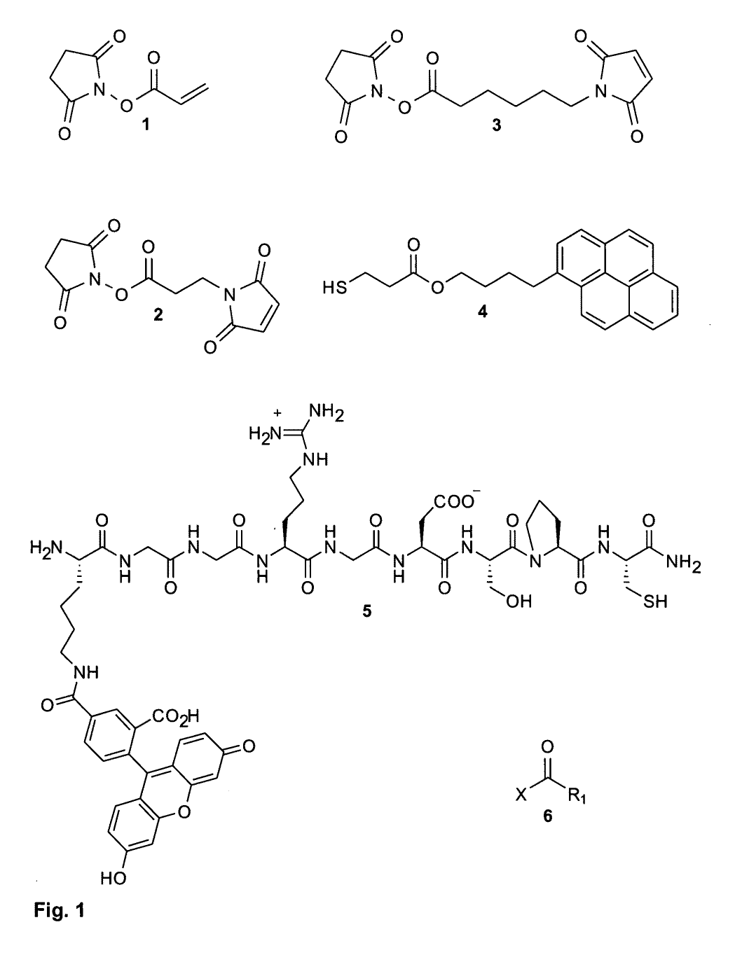

In one embodiment, the confining agent for confining the electrochemically-generated base is an activated ester attached to the Michael acceptor. Excess Michael acceptor is then added to solution for confinement of the base. In another embodiment, the confining agent is an added activated ester that is a part of the solution used to attach the Michael acceptor. The added activated ester for confining the electrochemically-generated base has the general formula shown in FIG. 1, compound (6), wherein X is R₂O—, wherein R₂ is selected from the group consisting of succinimide, pentafluorophenyl, para-nitrophenyl, benztriazole, and combinations thereof, and R₁ is any organic group or substituted organic group. R₁ can be an alkane, alkene, alkyne, or a ring structure of the foregoing. R₁ can be an aromatic compound or a substituted aromatic compound.

In another embodiment, the confining agent for confining the electrochemically-generated base is as shown in FIG. 1, compound (6), wherein R₁ is the Michael acceptor and X is a leaving group selected from the group consisting of fluoride, chloride, bromide, iodide, anhydride, and imidazolate and combinations thereof, or R₁ is any organic group or substituted organic group. R₁ can be an alkane, alkene, alkyne, or a ring structure of the foregoing. R₁ can be an aromatic compound or a substituted aromatic compound.

In another embodiment disclosed herein, the coupling reaction of chemicals from the library is between a thiol containing compound from the library and a Michael acceptor having a maleimide group. Other uses of the thiol-maleimide reaction include use for attaching peptides, sugars, or DNA to a maleimide-functionalized surface because the reaction occurs quickly with simple incubation at neutral pH in aqueous buffer. Xiao, S.-J.; Textor, M.; Spencer, N. D.; Sigrist, H. Langmuir 1998, 14, 5507; Houseman, B. T.; Gawalt, E. S.; Mrksich, M. Langmuir 2003, 19, 1522; and Schlapak, R.; Pammer, P.; Armitage, D.; Zhu, R.; Hinterdorfer, P.; Vaupel, M.; Frühwirth, T.; Howorka, S. Langmuir 2006, 22, 277. However, this reaction has not been performed site-selectively on a microarray of electrodes where confinement of the reaction to an individual electrode area is necessary in order to have proper registration of each chemical compound to a know location or locations.

In another embodiment disclosed herein, the Michael acceptors have a succinimide group attached to an ester group, where the succinimide group is cleaved during the transesterification reaction with the hydroxyls of the porous reaction layer. These Michael acceptors are reacted to the porous reaction layer using electrochemically-generated base at selected electrodes in order to selectively register a compound to a specific electrode location. Preferably, the Michael acceptors are N-succinimidyl 3-maleimidopropioate, N-succinimidyl 6-maleimidocaproate, and N-acryloxysuccinimide. Optionally, Michael acceptors with any activated esters may be used for attachment of the Michael acceptor. The activated ester may be a pentafluorophenol ester, para-nitrophenol ester, hydroxy-benztriazole ester, or some other activated ester. Optionally, Michael acceptors with acid halogenides may be used including acid fluoride, acid chloride, acid bromide, or acid iodide instead of activated esters. Optionally, Michael acceptors with imidizoleates may be used instead of activated esters. Optionally, Michael acceptors with acid anhydrides may be used instead of activated esters. Preferably, electrochemically-generated base is used for attaching the Michael acceptors to selected electrodes, and excess activated ester (the Michael acceptor) is used in solution to confine the electrochemically-generated base to the selected electrodes.

The Michael acceptor placement controls where the chemical from the library is attached; thus, where electrodes have a Michael acceptor, the chemical from the library will attach and where electrodes do not have a Michael acceptor, the chemical from the library will not attach. Attachment also is dependant upon whether a Michael acceptor has already had its olefin reacted from a prior attachment of a compound from the library; in other words, attachment will not occur on further additions of compounds from a library to locations that already have a compound attached from the library.

Other types of electrochemical reactions performed on electrode microarrays did not illustrate the level of selectivity demonstrated by the invention disclosed herein. Tian, J.; Maurer, K.; Tesfu, E.; Moeller, K. D. J. Am. Chem. Soc. 2005, 127, 1392; Tesfu, E.; Maurer, K.; Ragsdale, S. R.; Moeller, K. D. J. Am. Chem. Soc. 2004, 126, 6212; Chen, C.; Nagy, G.; Walker, A. V.; Maurer, K.; McShea, A.; Moeller, K. D. J. Am. Chem. Soc. 2006, 128, 16020. For example, with the chip-based Wacker oxidation, the electrogenerated base catalyzed esterification reaction was used to place a substrate at every electrode in the array. Confinement of the base to pre-selected electrodes was not an issue. The site-selectivity of product formation was then controlled in the subsequent Pd(II) reaction by adding ethyl vinyl ether as a confining agent to prevent the Pd(II) from migrating to neighboring electrodes. Tesfu, E.; Maurer, K.; Ragsdale, S. R.; Moeller, K. D. J. Am. Chem. Soc. 2004, 126, 6212.

Without being bound by theory, for the electrochemically-generated base initiated esterification reaction of the present invention, the activated ester substrate itself most likely acts as the confining reagent during attachment of the Michael acceptor. There are at least two possibilities for the degree of selectivity observed for placement of the Michael acceptor on the electrode microarray. First, the activated ester is present in high concentration; if deprotonation of the agarose by the radical anion of vitamin B12 occurs very rapidly, then the high concentration of the activated ester may quickly trap all of the alkoxide generated. Second, if the radical anion of vitamin B12 does migrate away from the electrode, the radical anion will undergo reaction with the methanol solvent to generate methoxide; the methoxide generated would also be rapidly scavenged by the high concentration of activated ester present near the active electrodes. Either way, no migration of base to neighboring electrodes not selected for the reduction was observed during attachment of the Michael acceptors.

Since the site-selectivity of the process reported does not depend on the subsequent reaction of the Michael acceptor to the library of chemical compounds, this subsequent reaction does not need to be electrochemically-catalyzed. For example, a microarray having the Michael acceptor N-acryloxysuccinimide (FIG. 1, formula 3) attached to selected electrodes was incubated in a solution containing a pyrene-thiol (4-(pyren-2-yl)butyl 3-mercaptopropionate, FIG. 1, formula 4) in order to add the pyrene to the surface of the electrode microarray without turning on the selected electrodes. However, while these conditions do work, most organic solvents damage or dissolve the agarose polymer (porous reaction layer) used to fix the substrates to the surface of the array during the time frame needed for the coupling reaction. Hence, for libraries that are soluble in organic solvents, the better approach is to use the electrochemical conditions to accelerate the coupling step and minimize damage to the agarose polymer.

However, not all molecular libraries are soluble in organic solvents; therefore, the electrochemical conditions used to generate base would not be suitable for the attachment of these libraries to the microarray. To attach biomolecules such as peptides, proteins, or DNA, the better approach is to site-selectively functionalize the microarray with the Michael acceptor and then incubate the functionalized array with an aqueous solution at approximately neutral pH of the biomolecule.

To screen libraries for binding to a receptor using a microelectrode array, there are advantages to using higher density microarrays since more molecules from a library can be placed on the microarray. Preferably, a microarray of approximately 12,000 electrodes is used. Preferably, a microarray of approximately 100,000 electrodes is used. Microarrays of larger numbers of electrodes may be used by increasing the array size, by decreasing the distance between electrodes, or both, provided confinement of the electrochemically-generated base is not compromised by smaller spacing between each electrode.

The present invention discloses the coupling of a thiol and a Michael acceptor, such as a maleimide or ethylene, to site-selectively attach molecules to microelectrode arrays. The electrodes of the 1K microarray were approximately 95 um in size and of the 12K microarray were approximately 45 um in size. Multiple couplings can be performed. With this chemistry, known libraries of both small molecules and biomolecules can be quickly moved onto the array.

Diversity oriented synthesis products are part of the library of chemicals that can be attached to a microarray and include chemicals made by a synthetic strategy where a central core scaffold is built in a manner that leaves it substituted with a variety of orthogonally protected amines and alcohols. The orthogonally protected term means that each group can be selectively deprotected without disturbing the others. The amines and alcohols are then deprotected one at a time and used to diversify the periphery of the molecule. Each newly deprotected alcohol and amine is used as the starting point for its own combinatorial synthesis. In this manner, millions of different molecules can be made for a single core scaffold.

### EXAMPLE 1

In this example, N-acryloxysuccimide (FIG. 1, formula 1) was placed on the surface of an electrode microarray having approximately 1000 electrodes, wherein a checkerboard pattern was formed using electrochemically-generated base at selected electrodes to form the pattern. Selected electrodes on the microarray were used as cathodes to reduce vitamin B₁₂, creating a base that catalyzed a transesterification reaction between the activated ester substrate and the hydroxyls on the surface of an agarose coating on the microarray; the agarose was the porous reaction layer. The electrode conditions for the reaction were as follows: −2.4 volts, 300 cycles, 0.5 sec on, and 0.1 sec off. The reaction mixture included the Michael acceptor in a solution containing Vitamin B₁₂, Me₄NNO₃, MeOH, and DMF. The solution was prepared by dissolving 6.0 mg N-acryloxysuccinimide (30 μmol) in 100 μL DMF in a 1.7 mL Eppendorf tube. To this solution was added 1.5 mL MeOH containing 2.77 mg Vitamin B₁₂ and 13.6 mg tetramethylammonium nitrate.

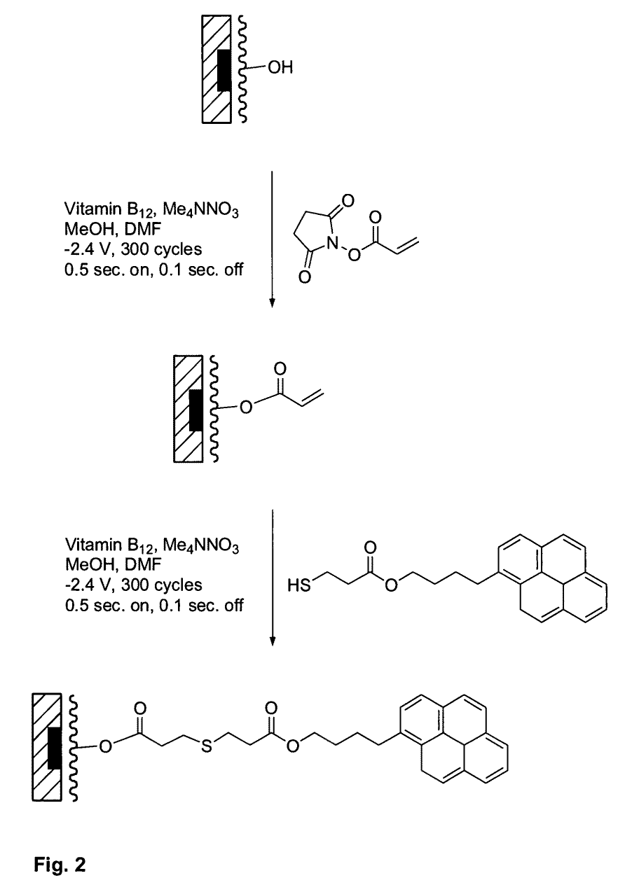

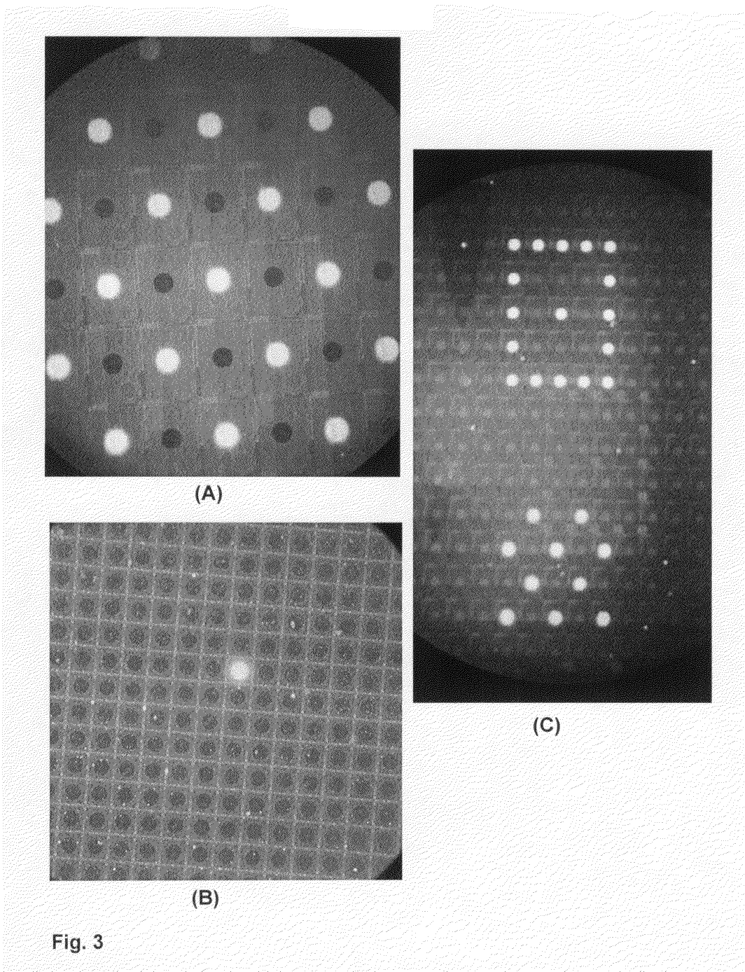

Following attachment of the Michael acceptor via transesterification, the olefin of the Michael acceptor was reacted using the same electrochemical-generated base conditions and the pattern used previously as well as the same concentrations but now using a pyrene-thiol (4-(pyren-2-yl)butyl 3-mercaptopropionate, FIG. 1, formula 4) as the substrate instead of the Michael acceptor. FIG. 2 provides a schematic of the method. The pyrene was used to provide a means to check for reaction using fluorescence. Using fluorescence microscopy, a clean, bright checkerboard pattern was observed as expected as shown in FIG. 3A.

### EXAMPLE 2

In another experiment, the Michael acceptors N-succinimidyl 3-maleimidopropioate (FIG. 1, formula 2) and N-succinimidyl 6-maleimidocaproate (FIG. 1, formula 3) (maleimide linkers) were used to attach the pyrene-thiol to the microarray using the same electrochemical-generated base conditions solution concentrations as used in Example 1. Fluorescence was observed on the microarray as expected for these Michael acceptors as was observed in Example 1 for the N-acryloxysuccimide.

### EXAMPLE 3

A control experiment was performed to show that the Michael acceptor must first be reacted to the microarray in order to attach the pyrene-thiol to the porous reaction layer of the microarray. The control experiment comprised attempting to react the pyrene-thiol of Example 1 to the microarray without first placing any Michael acceptor on the microarray. The electrochemical conditions and solutions concentrations were as in Example 1. Without a Michael acceptor, the pyrene-thiol (4) did not attach as evidenced by the lack of any fluorescent spots on those electrodes that were activated in an attempt to attach the pyrene-thiol.

### EXAMPLE 4

To show that the Michael acceptor placement controlled where the thiol reacted on the microarray, another experiment was performed where the Michael acceptor of Example 1 was placed on each electrode over the entire microarray using the solution concentrations and electrochemical conditions of Example 1. Following placement of the Michael acceptor, the pyrene-thiol of Example 1 was then reacted to the microarray using the solution concentrations and electrochemical conditions of Example I but turning on the electrodes in a checkerboard pattern on the microarray to generate thiolate. However, rather than having fluorescence only at the electrodes of the checkerboard pattern, equally bright spots were seen on every electrode in the microarray. Thus, the reaction of the pyrene-thiol occurred at those electrodes that were not turned on during the second step. With this result in mind, the selectivity observed in the initial experiments illustrated the site-selectivity of the electrochemically-generated base used in the esterification reaction to attach the Michael acceptors. Since the addition of a catalytic amount of a thiolate to an enone in the presence of excess thiol will cause the reaction to continue until all of the enone is consumed, the site-selectivity observed for reaction of the thiol on the microarray depends on the initial placement of the Michael acceptor onto the microarray and not the reaction of the Michael acceptor with the pyrene-thiol.

### EXAMPLE 5

In this example, a short RGD-based peptide was placed onto a microelectrode array. Peptides containing a RGD sequence are known to bind to integrins, cell-surface receptors that mediate cell attachment. The peptide KGGRGDSPC, with 5(6)-carboxyfluorescein attached to the amine of the lysine side chain, was synthesized using Fmoc solid phase peptide synthesis (FIG. 1, formula 5). The cysteine provided the thiol group for attachment to the Michael acceptor. The maleimide Michael acceptor N-succinimidyl 3-maleimidopropionate (FIG. 1, formula 2) was placed on the surface of an electrode microarray in a checkerboard pattern using 10 electrodes of a 1K microelectrode array. The microarray was then incubated in a 7.6 mM solution of the peptide in 5×PBS, pH 7.4. At this pH, the thiol is more nucleophilic than alcohols or amines. Gregory, J. D. J. Am. Chem. Soc. 1955, 77, 3922. The maleimide placement and peptide incubation were then repeated, this time giving a box and dot pattern as shown in FIG. 3B. Clearly, multiple reactions can be performed with this coupling strategy, allowing attachment of different thiol-containing library members to the polymer above selected electrodes in the microarray.

### EXAMPLE 6

In this example, Michael acceptors of different size were compared for confinement on an electrode microarray having approximately 12,000 electrodes, each having a feature size of approximately 45 micrometers. While moving to a microelectrode array with a larger density of electrodes can present a problem for the site-selectivity of a reaction, in the current case, the optimal conditions (Example 1) with the Michael acceptor N-acryloxysuccinimide (FIG. 1, formula 1) that gave confinement on a 1K chip (95 μm electrode diameter) also gave confinement to a single electrode on a 12K array (45 μm electrode diameter) as shown in FIG. 3C. When the maleimide linker N-succinimidyl 3-maleimidopropionate (FIG. 1, formula 2) was substituted for N-acryloxysuccinimide (FIG. 1, formula 1), the reaction was not confined to a single electrode on the 12K array; the size of the fluorescent spot observed was roughly the same size as an electrode on a 1K array. Using the Michael acceptor N-acryloxysuccinimide (FIG. 1, formula 1), an array of 12,000 molecules can be generated and screened since this Michael acceptor provided confinement. A higher concentration of Michael acceptor may possibly provide better confinement.

What is claimed is:

1. A process for making a microarray having a library of chemical compounds that are attached at known locations on the microarray, comprising:
(a) providing a microarray having addressable electrodes, wherein a porous reaction layer is attached to each one of the addressable electrodes, wherein the porous reaction layer that is attached to each one of the addressable electrodes is a known location, wherein the porous reaction layer has hydroxyl groups;
(b) attaching a Michael acceptor having an attaching group to one of the known locations by a base-catalyzed chemical reaction that occurs at the hydroxyl groups, wherein the base for the base-catalyzed chemical reaction is an electrochemically-generated base that is generated by activating the addressable electrode at the known location, wherein the electrochemically-generated base is confined to a region surrounding the addressable electrode at the known location using a scavenging agent;
(c) attaching a chemical compound from a chemical library to the olefin of the Michael acceptor that is attached to one of the known locations; and
(d) repeating steps (b) through (c) until each member of the chemical library is attached to at least one of the known locations.

2. The process of claim 1, wherein the attaching group is an activated ester and the base-catalyzed chemical reaction attaching the Michael acceptor is an esterification reaction of the activated ester, wherein the activated ester attached to the Michael acceptor acts as the scavenging agent, wherein the activated ester is activated by a chemical selected from the group consisting of succinimide, pentafluorophenol, para-nitrophenol, and hydroxy-benztriazole and combinations thereof.

3. The process of claim 1, wherein the attaching group is selected from the group consisting of acid fluoride, acid anhydride, and imidazolate and combinations thereof, wherein the attaching group attached to the Michael acceptor acts as the scavenging agent.

4. The process of claim 1, wherein the scavenging agent is 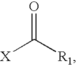
wherein X is a leaving group selected from the group consisting of fluoride, chloride, bromide, iodide, anhydride, imidazolate, and R₂O—, and combinations thereof, wherein R₁ is selected from the group consisting of alkyl, alkenyl, alkynyl, and aryl and combinations thereof, wherein R₂ is selected from the group consisting of succinimide, pentafluorophenyl, para-nitrophenyl, and benztriazole and combinations thereof.

5. The process of claim 1, wherein the olefin of the Michael acceptors is selected from the group consisting of ethylene and maleimide and combinations thereof.

6. The process of claim 1, wherein the Michael acceptors are selected from the group consisting of N-succinimidyl 3-maleimidopropioate, N-succinimidyl 6-maleimidocaproate, and N-acryloxysuccinimide and combinations thereof.

7. The process of claim 1, wherein the step of attaching a chemical compound from a chemical library to the olefin of the Michael acceptor that is attached to one of the known locations, further comprises: attaching using chemical base or electrochemically-generated base that is generated by activating the addressable electrode at the known location.

8. The process of claim 1, wherein each of the chemical compounds from the chemical library has a thiol group, wherein the thiol group reacts with the olefin of the Michael acceptors, whereby the chemical compounds from the chemical library are attached to the Michael acceptors through a sulfide linkage.

9. The process of claim 1, wherein the chemical library is selected from the group consisting of peptides, peptidomimetics, proteins, DNA, RNA, small molecule drug candidates, diversity oriented synthesis products, and functionalized members of the foregoing and combinations thereof.

10. A microarray having a library of chemical compounds that are attached at known locations on the microarray, comprising:
(a) a microarray having addressable electrodes, wherein a porous reaction layer is attached to each one of the addressable electrodes, wherein the porous reaction layer that is attached to each one of the addressable electrodes is a known location, wherein the porous reaction layer has hydroxyl groups;
(b) Michael acceptors having an attaching group and attached to each one of the known locations by a base-catalyzed chemical reaction that occurs at the hydroxyl groups, wherein the base for the base-catalyzed chemical reaction is an electrochemically-generated base that is generated by activating the addressable electrode at the known location, wherein the electrochemically-generated base is confined to a region surrounding the addressable electrode at the known location using a scavenging agent; and
(c) a chemical compound from a chemical library attached to the olefin of each one of the Michael acceptors.

11. The microarray of claim 10, wherein the attaching group is an activated ester and the base-catalyzed chemical reaction attaching the Michael acceptors is an esterification reaction of the activated ester, wherein the activated ester attached to the Michael acceptor acts as the scavenging agent, wherein the activated ester is activated by a chemical selected from the group consisting of succinimide, pentafluorophenol, para-nitrophenol, and hydroxy-benztriazole and combinations thereof.

12. The microarray of claim 10, wherein the attaching group is selected from the group consisting of acid fluoride, acid anhydride, and imidazolate and combinations thereof, wherein the attaching group attached to the Michael acceptor acts as the scavenging agent.

13. The microarray of claim 10, wherein the scavenging agent is 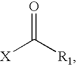
wherein X is a leaving group selected from the group consisting of fluoride, chloride, bromide, iodide, anhydride, imidazolate, and R₂O—, and combinations thereof, wherein R₁ is selected from the group consisting of alkyl, alkenyl, alkynyl, and aryl and combinations thereof, wherein R₂ is selected from the group consisting of succinimide, pentafluorophenyl, para-nitrophenyl, and benztriazole and combinations thereof.

14. The microarray of claim 10, wherein the olefin of the Michael acceptors is selected from the group consisting of ethylene and maleimide and combinations thereof.

15. The microarray of claim 10, wherein the Michael acceptors are selected from the group consisting of N-succinimidyl 3-male-imidopropioate, N-succinimidyl 6-maleimidocaproate, and N-acryloxysuccinimide and combinations thereof.

16. The microarray of claim 10, wherein the chemical compounds from the chemical library are attached using chemical base or electrochemically-generated base that is generated by activating the addressable electrode at the known location.

17. The microarray of claim 10, wherein each of the chemical compounds from the chemical library has a thiol group, wherein the thiol group reacts with the olefin of the Michael acceptors, whereby the chemical compounds from the chemical library are attached to the Michael acceptors through a sulfide linkage.

18. The microarray of claim 10, wherein the chemical library is selected from the group consisting of peptides, peptidomimetics, proteins, DNA, RNA, small molecule drug candidates, diversity oriented synthesis products, and functionalized members of the foregoing and combinations thereof.
